(19) United States
(12) Patent Application Publication
(10) Pub. No.: US 2020/0088860 A1
(43) Pub. Date: Mar. 19, 2020

(54) COHERENT FMCW LIDAR SYSTEM

(71) Applicants: Hyun-Ju PARK, Seoul (KR); INFOWORKS INC., Seoul (KR)

(72) Inventor: Hyun-Ju PARK, Seoul (KR)

(73) Assignees: INFOWORKS INC., Seoul (KR); Hyun-Ju PARK, Seoul (KR)

(21) Appl. No.: 16/618,688

(22) PCT Filed: Apr. 29, 2019
(86) PCT No.: PCT/KR2019/005155

§ 371 Date: Dec. 2, 2019

(30) Foreign Application Priority Data
Apr. 27, 2018 (KR) 10-2018-0049044
Jan. 22, 2019 (KR) 10-2019-008173

(51) Int. Cl. G01S 7/4911; G01S 7/4912; G01S 17/89; G01S 7/481; G01S 17/36

(52) U.S. Cl. CPC G01S 7/4911; G01S 7/4916; G01S 17/36; G01S 7/4817; G01S 17/89

(57) ABSTRACT

The present invention relates to a coherent frequency modulated continuous wave (FMCW) lidar system, and more particularly, to a coherent FMCW lidar system including: a lidar sensor unit configured to generate an amplified laser by interfering a first FMCW laser, which is reference light, and a second FMCW laser, which is transmitted over sea and reflected, in a coherent scheme, and detect a marine object information signal from the amplified laser; a control unit (200) configured to process the marine object information signal received from the lidar sensor unit (100) into an image; and a housing unit (10) configured to house the lidar sensor unit (100) and the control unit (200).

### TECHNICAL FIELD

The present invention relates to a lidar system, and more particularly, to a coherent frequency modulated continuous wave (FMCW) lidar system that divides and oscillates an FMCW laser from a laser oscillator into reference light and search light for detecting a marine object, generates an amplified laser by interfering the reference light and reflected search light in a coherent scheme, and processes a marine object information signal detected from the amplified laser into an image, so that a marine object existing outside a visible range can be detected even when heavy fog such as sea fog occurs at the sea.

### BACKGROUND ART

Recently, due to the development of global positioning system (GPS) and various sensors, it can be said that a vehicle can autonomously travel along a path having the shortest distance without difficulty, but it is not so in the operation of a ship.

In particular, unlike other land vehicles such as automobiles and motorcycles, it is very difficult to adjust the speed or direction of ships immediately because the ships have very large inertial force due to the nature of the ships operating under water.

Furthermore, since the sea has no designated roads like the land and is greatly influenced by various factors such as the weather, it is very difficult to navigate on a scheduled route. Crews have to always look ahead so as to avoid collisions with other ships, reefs, and the like. However, due to the nature of the sea, the visual range is often very short due to a sea fog that is a fog on the sea. Hence, it is very difficult to grasp all the seas with the naked eyes.

Therefore, the present invention proposes a coherent frequency modulated continuous wave (FMCW) lidar system that divides and oscillates an FMCW laser from a laser oscillator into reference light and search light for detecting a marine object, generates an amplified laser by interfering the reference light and reflected search light in a coherent scheme, and processes a marine object information signal detected from the amplified laser into an image, so that a marine object existing outside a visible range can be detected even when heavy fog such as sea fog occurs at the sea.

### DESCRIPTION OF EMBODIMENTS

### Technical Problem

The present invention has been made in an effort to solve the problems of the related art.

An object of the present invention is to provide a coherent frequency modulated continuous wave (FMCW) lidar system that generates an amplified laser by interfering a first FMCW laser, which is reference light, and a second FMCW laser, which is transmitted over sea and reflected, in a coherent scheme, and generates a marine object information signal from the amplified laser, so that a marine object can be detected outside a visible range even when heavy fog such as sea fog occurs at the sea.

### Solution to Problem

In order to achieve the above-described objects, the present invention includes: a lidar sensor unit configured to generate an amplified laser by interfering a first coherent frequency modulated continuous wave (FMCW) laser, which is reference light, and a second FMCW laser, which is transmitted over sea and reflected, in a coherent scheme, and detect a marine object information signal from the amplified laser; a control unit configured to process the marine object information signal received from the lidar sensor unit into an image; and a housing unit configured to house the lidar sensor unit and the control unit.

In addition, the lidar sensor unit includes: a laser oscillator configured to oscillate the first FMCW laser and the second FMCW laser; a laser amplifier configured to amplify the second FMCW laser; a light transmitting and receiving optical system configured to remove an afterimage caused by internal reflection of the amplified second FMCW laser; a scanner module configured to scan the second FMCW laser, from which the afterimage is removed, transmit the scanned second FMCW laser to the sea, and, when the transmitted second FMCW laser is reflected by a marine object, rescan the reflected second FMCW laser having the marine object information signal; a laser interferometer configured to generate an amplified laser by interfering the first FMCW laser and the rescanned second FMCW laser in a coherent scheme; a detector module configured to detect the marine object information signal from the laser amplified by the laser interferometer; and a logic module configured convert at least one of the marine object information signal, scanner position information received from the scanner module, and position/posture information received from a global positioning system/inertial measurement unit (GPS/IMU) into a form capable of being identified by the control unit, and provide the at least one of the converted marine object information signal, the converted scanner position information, and the converted position/posture information, or transmit a control signal received from the control unit to at least one of the detector module, the scanner module, and the GPS/IMU.

In addition, the laser oscillator has an optical phase locked loop (PLL) structure.

In addition, the light transmitting and receiving optical system has a uniaxial light transmitting and receiving optical system.

In addition, the light transmitting and receiving optical system is configured to remove an afterimage of the rescanned second FMCW laser and transmit the resulting laser to the laser interferometer.

In addition, the scanner module has a galvanometer scan structure.

In addition, the marine object information signal includes at least one of a position signal, a moving speed, a moving direction, and object shape information of the marine object.

In addition, the control unit includes: a sensor unit controller configured to control the lidar sensor unit through a logic module; and an image processing unit configured to display the marine object information signal on a screen.

In addition, the housing unit has an IP68 rating.

### Advantageous Effects of Invention

A coherent frequency modulated continuous wave (FMCW) lidar system according to the present invention can detect a marine object outside a visible range even when heavy fog such as sea fog occurs at the sea, thereby providing a safer navigation to prevent collisions with marine objects.

### BRIEF DESCRIPTION OF DRAWING

FIG. 1 is a schematic view of a coherent FMCW lidar system according to the present invention.

### BEST MODE

Advantages and features of the present invention and methods for achieving them will become apparent from embodiments described in detail below. However, it will be understood that the present invention is not limited to the following embodiments, and various modifications can be made without departing from the scope of the present invention. The embodiments set forth herein are provided so that the present disclosure will be thorough and complete, and will fully convey the concept of the invention to those skilled in the art. The present invention should be defined by the appended claims.

Since shapes, sizes, ratios, angles, numbers, etc. for describing the embodiments of the present invention are merely exemplary, the present invention is not limited thereto. In relation to describing the present invention, when the detailed description of the relevant known technology is determined to unnecessarily obscure the gist of the present invention, the detailed description thereof may be omitted.

When the terms “comprise,” “have,” and “including” mentioned in the present specification are used, other parts may be added unless the term “only” is used. The singular forms “a,” “an,” and “the” may be intended to include the plural forms as well, unless the context clearly indicates otherwise.

In interpreting the components, it is interpreted as including an error range even if there is no separate explicit description.

In addition, when a positional relationship is described, for example, when a positional relationship of two parts is described by using the terms “on,” “above,” “below,” “beside,” etc., one or more other parts may be positioned between the two parts, unless the terms “just” or “directly” is used.

When a temporal relationship is described, for example, when a temporal relationship is described by using the terms “after,” “following,” “subsequently” “before,” etc., it may also include discontinuous cases unless the terms “just” or “directly” is used.

Furthermore, it will be understood that although the terms “first,” “second,” etc. may be used herein to describe various components, these components should not be limited by these terms. These terms are only used to distinguish one component from another. Therefore, a first component described below may be a second component within the spirit of the present invention.

“X-axis direction, “Y-axis direction,” and “Z-axis direction” should not be interpreted only based on geometric relationships in which the X-axis direction, the Y-axis direction, and the Z-axis direction are perpendicular to each other, and may mean that the configuration of the present invention has a wider directionality within the range that can be functionally operated.

It will be also understood that the term “at least one” includes all possible combinations that can be presented from one or more relevant items. For example, “at least one of a first item, a second item, and a third items” may mean not only the first item, the second item, and the third item, but also a combination of all the items that can be presented from two or more of the first item, the second item, and the third item.

The features of various embodiments of the present invention may be partly or wholly connected or combined with each other and may be technically variously interworked and driven, and the respective embodiments may be independently performed with respect to each other and may be performed together in a implemented in association with each other.

Hereinafter, a coherent frequency modulated continuous wave (FMCW) lidar system according to the present invention will be described with reference to the accompanying drawings.

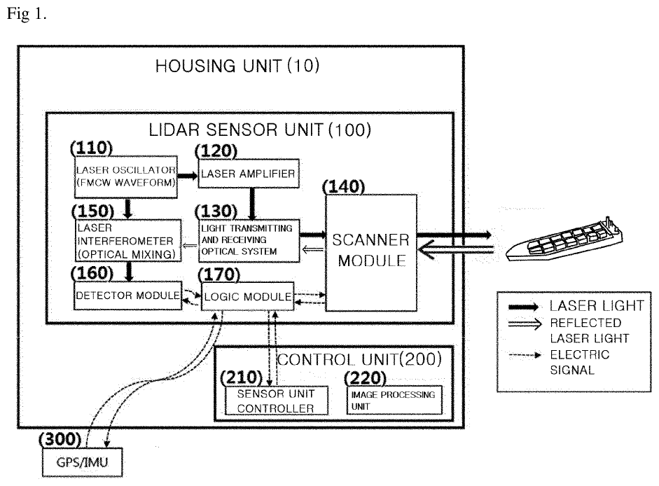

FIG. 1 is a schematic view of a coherent FMCW lidar system according to the present invention.

The coherent FMCW lidar system according to the present invention may basically include a lidar sensor unit 100, a control unit 200, and a housing unit 10.

In a conventional commercial lidar system, space scanning is impossible in a smoke environment such as fog, smog, and sea fog. However, the coherent FMCW lidar system has an effect that can detect signals even when a visible distance is less than 1 meter.

The lidar sensor unit 100 is configured to interfere a first FMCW laser, which is reference light, and a second FMCW laser, which is transmitted over the sea and reflected and has a marine object information signal, in a coherent scheme and then detect the marine object information signal from the second FMCW laser. The coherent scheme of the lidar sensor unit 100 has an effect that amplifies a weak marine object information signal of the second FMCW laser having passed through smoke such as fog, smog, and sea fog.

The control unit is configured to receive the marine object information signal detected by the lidar sensor unit 100 and process the received marine object information signal into an image. In this case, the control unit 200 may perform 4096 pts FFT in 50 us periods, and the frequency in FFT conversion may be in the range of 0.1 MHz to 50 MHz.

The housing unit 10 is configured to house the lidar sensor unit 100 and the control unit 200.

Specifically, the lidar sensor unit 100 may be configured to include a laser oscillator 110, a laser amplifier 120, a light transmitting and receiving optical system 130, a scanner module 140, a laser interferometer 150, a detector module 160, and a logic module 170.

The laser oscillator 110 is configured to oscillate the first FMCW laser and the second FMCW laser. The laser oscillator 110 may have an optical phase locked loop (PLL) structure. Due to the optical PLL structure, the laser oscillator 110 has an effect that can linearize and stabilize the frequency. The PLL is a circuit for oscillating a voltage controlled oscillator (VCO) at the same frequency as an input frequency. The PLL may match an input signal and a reference frequency, and an output signal and a frequency, detect a phase difference between the input signal and the output signal, and control the VCO to transmit an accurately locked frequency signal.

The laser amplifier 120 is configured to receive and amplify the second FMCW laser. The laser amplifier 120 amplifies the second FMCW laser so that the second FMCW laser is reflected from the marine object after passing through smoke such as smog or see fog.

The light transmitting and receiving optical system 130 is configured to receive the amplified second FMCW laser output from the laser amplifier 120 and remove an afterimage caused by internal reflection. Due to the afterimage removal, the light transmitting and receiving optical system 130 has an effect that can detect a clear marine object information signal from the amplified second FMCW laser.

The scanner module 140 scans the second FMCW laser, from which the afterimage is removed by the light transmitting and receiving optical system 130, and transmits the scanned second FMCW laser to the sea. When the transmitted second FMCW laser is reflected from the marine object, the scanner module 140 rescans the reflected second FMCW laser including the marine object information signal storing information about the marine object and transmits the rescanned second FMCW laser to the light transmitting and receiving optical system 130. In this manner, the scanner module 140 has an effect that can collect the reflected marine object information signal of the marine object.

The laser interferometer 150 is configured to generate an amplified laser by interfering the first FMCW laser and the second FMCW laser rescanned by the scanner module in a coherent scheme. Due to the coherent scheme, the laser interferometer 150 has an effect that amplifies the weak marine object information signal of the second FMCW laser having passed through smoke such as fog, smog, or see fog. In this case, the laser interferometer 150 may use a polarization control interferometer technology to improve the interference efficiency of the weak marine object information signal and may use a technology for suppressing the generation of an afterimage caused by an optical discontinuous surface or non-uniform surface.

The detector module 160 is configured to detect the marine object information signal from the second FMCW laser amplified by the laser interferometer 150, and serves to transmit the detected marine object information signal to the control unit 200 through the logic module 170.

The logic module 170 is configured to transmit, to the control unit 200, at least one of position/posture information received from a global positioning system/inertial measurement unit (GPS/IMU) 300 and the marine object information signal received by the detector module. The logic module 170 may serve to convert the received position/posture information and marine object information signal into a form capable of being identified by the control unit 200 and provide the converted position/posture information and marine object information signal, or transmit a control signal received from the control unit 200 to at least one of the detector module 160, the scanner module 140, and the GPS/IMU 300.

In addition, the light transmitting and receiving optical system 130 may be a uniaxial light transmitting and receiving optical system. The uniaxial light transmitting and receiving optical system has an effect that can easily measure a short distance and a long distance at the same time.

In addition, the light transmitting and receiving optical system 130 is configured to remove the afterimage of the rescanned second FMCW laser and transmit the resulting laser to the laser interferometer 150. Therefore, the laser interferometer 150 has an effect that can more accurately detect the marine object information signal from the laser, from which the afterimage is removed.

In addition, the scanner module 140 may have a galvanometer scan structure. The scanner module 140 having the galvanometer scan structure has an effect that is capable of high-speed raster scan pattern and random scan.

In addition, the marine object information signal may be configured to include at least one of a position signal, a moving speed, a moving direction, and object shape information of the marine object.

In addition, the control unit 200 may be configured to include a sensor unit controller 210 for controlling the lidar sensor unit 100 through the logic module, and an image processing unit 220 for displaying the marine object information signal on a screen.

In addition, the sensor unit controller 210 may control operations by transmitting the control signal through the logic module 170 to at least one of the laser oscillator 110, the laser amplifier 120, the light transmitting and receiving optical system 130, the scanner module 140, the laser interferometer 150, and the detector module 160, which constitute the lidar sensor unit 100.

In addition, the image processing unit 220 may receive at least one of the position/posture information and the marine object information signal from the control unit 200 and display the at least one of the position/posture information and the marine object information signal on a displayer.

Furthermore, the housing unit 10 has an IP68 rating. The IP refers to ingress protection, and the IP68 rating refers to a rating having a complete dustproof structure and a waterproof structure that can be used under water. The housing unit 10 may include a signal transfer unit configured to transfer signals generated by the lidar sensor unit 100 and the control unit 200. In this case, the signal transfer unit may include a cable, a connector, and the like. Moreover, since the housing unit 10 has the IP68 rating, the housing unit 10 may safely protect the lidar sensor unit 100, the control unit 200, and the signal transfer unit from water or dust.

While the embodiments of the present invention have been described in more detail, the present invention is not necessarily limited to these embodiments and various modifications can be made thereto without departing from the spirit of the present invention.

Therefore, the embodiments of the present invention are not intended to limit the technical idea of the present invention but to describe the technical idea of the present invention, and the scope of the present invention is not limited by these embodiments.

Thus, it will be understood that the above-described embodiments are illustrative in all aspects and not restrictive. The scope of protection of the present invention should be interpreted by the appended claims, and all technical ideas within the scope of equivalents should be construed as falling within the scope of the present invention.

1. A coherent frequency modulated continuous wave (FMCW) lidar system comprising:
a lidar sensor unit configured to generate an amplified laser by interfering a first FMCW laser, which is reference light, and a second FMCW laser, which is transmitted over sea and reflected, in a coherent scheme, and detect a marine object information signal from the amplified laser;
a control unit (200) configured to process the marine object information signal received from the lidar sensor unit (100) into an image; and
a housing unit (10) configured to house the lidar sensor unit (100) and the control unit (200).

2. The coherent FMCW lidar system of claim 1, wherein the lidar sensor unit (100) comprises:
a laser oscillator (110) configured to oscillate the first FMCW laser and the second FMCW laser;
a laser amplifier (120) configured to amplify the second FMCW laser;
a light transmitting and receiving optical system (130) configured to remove an afterimage caused by internal reflection of the amplified second FMCW laser;
a scanner module (140) configured to scan the second FMCW laser, from which the afterimage is removed, transmit the scanned second FMCW laser to the sea, and, when the transmitted second FMCW laser is reflected by a marine object, rescan the reflected second FMCW laser having the marine object information signal;
a laser interferometer (150) configured to generate an amplified laser by interfering the first FMCW laser and the rescanned second FMCW laser in a coherent scheme;
a detector module (160) configured to detect the marine object information signal from the laser amplified by the laser interferometer (150); and
a logic module (170) configured convert at least one of the marine object information signal, scanner position information received from the scanner module (140), and position/posture information received from a global positioning system/inertial measurement unit (GPS/IMU) into a form capable of being identified by the control unit (200), and provide the at least one of the converted marine object information signal, the converted scanner position information, and the converted position/posture information, or transmit a control signal received from the control unit (200) to at least one of the detector module (160), the scanner module (140), and the GPS/IMU (300).

3. The coherent FMCW lidar system of claim 2, wherein the laser oscillator (110) has an optical phase locked loop (PLL) structure.

4. The coherent FMCW lidar system of claim 2, wherein the light transmitting and receiving optical system (130) has a uniaxial light transmitting and receiving optical system.

5. The coherent FMCW lidar system of claim 2, wherein the light transmitting and receiving optical system (130) is configured to remove an afterimage of the rescanned second FMCW laser and transmit the resulting laser to the laser interferometer (150).

6. The coherent FMCW lidar system of claim 2, wherein the scanner module (140) has a galvanometer scan structure.

7. The coherent FMCW lidar system of claim 2, wherein the marine object information signal comprises at least one of a position signal, a moving speed, a moving direction, and object shape information of the marine object.

8. The coherent FMCW lidar system of claim 1, wherein the control unit (200) comprises:
a sensor unit controller (210) configured to control the lidar sensor unit (100) through a logic module; and
an image processing unit (220) configured to display the marine object information signal on a screen.

9. The coherent FMCW lidar system of claim 1, wherein the housing unit (10) has an IP68 rating.
